(19) United States
(12) Patent Application Publication
(10) Pub. No.: US 2007/0046797 A1
(43) Pub. Date: Mar. 1, 2007

(54) Solid-state image-sensing device

(75) Inventor: Tomokazu Kakumoto, Yokohama-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/511,659

(22) Filed: Aug. 29, 2006

(30) Foreign Application Priority Data
Aug. 30, 2005 (JP) 2005-248592
May 24, 2006 (JP) 2006-144218

(51) Int. Cl. H04N 5/335

(52) U.S. Cl. 348/294

(57) ABSTRACT

An image signal, a noise signal, and an overflow signal outputted from a solid-state image-sensing device are sampled-and-held in capacitors C1, C2, and C3 in a sample-and-hold circuit 17. Thereafter, the image signal and the noise signal in the capacitors C1 and C2 are fed to a subtractor 50 in a correction circuit 18, so that the image signal having noise eliminated therefrom is fed to an operator 51. In this operator 51, according to the value of the overflow signal in the capacitor C3, the image signal having noise eliminated therefrom is corrected by adding thereto an integrated component.

This application is based on Japanese Patent Application No. 2005-248592 filed on Aug. 30, 2005 and Japanese Patent Application No. 2006-144218 filed on May 24, 2006, the contents of both of which are hereby incorporated by reference.

### BACKGROUND OF THE INVENTION

1. Field of the Invention

The present invention relates to a solid-state image-sensing device provided with pixels that output electrical signals commensurate with incident light, and more particularly to a solid-state image-sensing device of which the pixels are built with transistors.

2. Description of Related Art

Finding many uses, solid-state image-sensing devices are largely classified into a CCD type and a CMOS type according to the means they use to read (extract) photoelectric charges produced by photoelectric conversion elements. In a CCD-type solid-state image-sensing device, photoelectric charges are transferred while being accumulated in potential wells. This leads to a disadvantageously narrow dynamic range. On the other hand, in a CMOS-type solid-state image-sensing device, photoelectric charges accumulated in the pn-junction capacitance of photodiodes are directly read out via MOS transistors.

Some conventional CMOS-type solid-state image-sensing devices operate logarithmically by logarithmically converting the amount of incident light (see JP-A-H11-313257). These solid-state image-sensing devices offer wide, namely five- to six-digit, dynamic ranges, and thus permit, even when a subject having a slightly wider-than-usual brightness distribution is shot, all the brightness information within the brightness distribution to be converted into electrical signals for output. This, however, makes the shootable brightness range wider relative to the brightness distribution of the subject, and thus creates, in low-brightness and high-brightness regions within the shootable brightness range, regions where no brightness data is available.

Under this background, the applicant of the present invention once proposed a CMOS-type solid-state image-sensing device that can be switched between linear and logarithmic conversion as described above (see JP-A-2002-077733). The applicant of the present invention also once proposed a CMOS-type solid-state image-sensing device in which, for the purpose of automatically performing such switching between linear and logarithmic conversion, the transistors connected to photodiodes that perform photoelectric conversion are brought into a proper potential state (see JP-A-2002-300476). In this solid-state image-sensing device, by changing the potential state of those transistors, the inflection point across which their photoelectric conversion switches from linear to logarithmic conversion or vice versa can be changed.

JP-A-2002-300476 mentioned above discloses a solid-state image-sensing device provided with pixels having a circuit configuration as shown FIG. 9. This solid-state image-sensing device is provided with, in each pixel: a photodiode PD that serves as a photosensitive element; a MOS transistor T1 whose source is connected to the cathode of the photodiode PD; a MOS transistor T2 whose source is connected to the drain of the MOS transistor T1; a MOS transistor T3 whose gate is connected to the drain of the MOS transistor T1 and to the source of the MOS transistor T2; and a MOS transistor T4 whose drain is connected to the source of the MOS transistor T3.

A direct-current voltage VPS is applied to the anode of the photodiode PD and to the backgates of the MOS transistors T1 to T4, and direct-current voltages VRS and VPD are applied to the drains of the MOS transistors T2 and T3, respectively. Moreover, signals φTX, φRS, and φV are fed to the gates of the MOS transistors T1, T2, and T4, respectively, and the source of the MOS transistor T4 is connected to an output signal line 14. The MOS transistors T1 to T4 are all N-channel MOS transistors.

In the pixel configured as described above, when the gate voltage fed to the gate of the MOS transistor T1 is set at an intermediate voltage, the operation of the pixel can be switched between linear conversion, whereby an electrical signal is produced that varies linearly with respect to the amount of incident light, and logarithmical conversion, whereby an electrical signal is produced that varies logarithmically with respect to the amount of incident light.

Moreover, as shown in FIG. 11, the solid-state image-sensing device whose pixels are configured as described above is provided with, for each column: an output signal line 14 via which the image signals and the noise signals from the pixels in different rows are outputted; a constant-current source 16 that is connected to the output signal line 14; switches S1 and S2 that is connected to the output signal line 14; and capacitors C1 and C2 and buffers A1 and A2 that are connected via the switches S1 and S2 to the output signal line 14. There is also provided a subtracter 50 built with a differential amplifier circuit that receives the outputs of the buffer amplifiers A1 and A2 of each column.

With this configuration, when the pixel outputs a noise signal, the switch S2 turns on, so that the noise signal is sampled-and-held in the capacitor C2. Thereafter, when the pixel outputs an image signal, the switch S1 turns on, so that the image signal is sampled-and-held in the capacitor C1. Then, the image signal and the noise signal thus sampled-and-held in the capacitors C1 and C2, respectively, are fed to the subtracter 50, which then outputs an image signal having noise eliminated therefrom. A circuit configuration similar to that shown in FIG. 9 is adopted in the pixels provided in another conventionally proposed solid-state image-sensing device of the type in which signal charges internally accumulated by photodiodes through photoelectric conversion of the amount of incident light into corresponding amounts electric charge are transferred via transfer transistors to floating nodes (see JP-A-2002-051263).

In the solid-state image-sensing device disclosed in JP-A-2002-300476 mentioned above, whose pixels are configured as shown in FIG. 9, when an image signal is outputted through linear conversion, the photoelectric charge generated by the photodiode PD according to incident light is accumulated so that, without provision of an integrating circuit, an integrated image signal is outputted. By contrast, when an image signal is outputted through logarithmic conversion, irrespective of variation of the amount of incident light during the exposure period, an image signal is outputted with its value as observed at the moment that the MOS transistor T1 turns off. In this way, the pixel configured as shown in FIG. 9 outputs either an integrated, linearly converted image signal or a non-integrated, logarithmically converted image signal.

Thus, in situations where the amount of incident light is likely to vary, as during long-period exposure or in flash shooting, and in addition where a logarithmically converted image signal is outputted, as when the brightness of the subject is high, it is disadvantageously impossible to acquire accurate information on the subject. This may be overcome by furnishing each pixel of the solid-state image-sensing device with an integrating capability. Doing so, however, requires that each pixel be additionally provided with a transistor for amplification, a capacitive element such as a capacitor for integration, and a transistor for resetting the capacitive element. This disadvantageously increases the size of each pixel, leading to a lower aperture ratio.

### SUMMARY OF THE INVENTION

In view of the conventionally experienced disadvantages mentioned above, it is an object of the present invention to provide a solid-state image-sensing device that can be additionally furnished with an integrating capability without provision of an additional element in each pixel.

To achieve the above object, according to one aspect of the present invention, a solid-state image-sensing device is provided with: a pixel including a photoelectric conversion element that generates and internally accumulates a photoelectric charge according to the amount of incident light, a charge holder that temporarily holds the photoelectric charge transferred from the photoelectric conversion element, and a transfer gate that is formed between the photoelectric conversion element and the charge holder, the pixel performing non-integrating image sensing to yield an output commensurate with the amount of incident light observed at the moment that the transfer gate performs transfer; and a calculation circuit that reads out from the pixel, as an overflow signal, the photoelectric charge that overflows from the photoelectric conversion element via the transfer gate to be accumulated in the charge holder while the pixel is performing the image sensing, and that performs correction on, based on the overflow signal, an image signal outputted from the pixel having performed the non-integrating image sensing.

According to another aspect of the present invention, a solid-state image-sensing device is provided with: a pixel including a photoelectric conversion element that generates and internally accumulates a photoelectric charge according to the amount of incident light, a charge holder that temporarily holds the photoelectric charge transferred from the photoelectric conversion element, a transfer gate that is formed between the photoelectric conversion element and the charge holder, and a reset gate via which the potential state of the charge holder is initialized, the pixel performing non-integrating image sensing to yield an output commensurate with the amount of incident light observed at the moment that the transfer gate performs transfer; and a calculation circuit that reads out from the pixel, as an overflow signal, the photoelectric charge that overflows from the photoelectric conversion element via the transfer gate to be accumulated in the charge holder while the pixel is performing the image sensing, and that performs correction on, based on the overflow signal, an image signal outputted from the pixel having performed the non-integrating image sensing, and a sample-and-hold-circuit that temporarily holds the image signal and the overflow signal outputted from the pixel. Here, when the pixel performs the image sensing, the charge holder is made, via the reset gate, ready to hold the photoelectric charge overflowing from the photoelectric conversion element via the transfer gate, and, when the pixel outputs a signal, the photoelectric charge accumulated in the charge holder is read out as the overflow signal, then the charge holder is initialized via the reset gate, and then the photoelectric charge accumulated in the photoelectric conversion element is read out as the image signal via the charge holder.

According to still another aspect of the present invention, a solid-state image-sensing device is provided with: a pixel including a photoelectric conversion element that generates and internally accumulates a photoelectric charge according to the amount of incident light, a charge holder that temporarily holds the photoelectric charge transferred from the photoelectric conversion element, and a transfer gate that is formed between the photoelectric conversion element and the charge holder, the pixel performing non-integrating image sensing to yield an output commensurate with the amount of incident light observed at the moment that the transfer gate performs transfer; and a calculation circuit that reads out from the pixel, as an overflow signal, the photoelectric charge that overflows from the photoelectric conversion element via the transfer gate to be accumulated in the charge holder while the pixel is performing the image sensing, and that performs correction on, based on the overflow signal, an image signal outputted from the pixel having performed the non-integrating image sensing. Here, when the pixel performs the image sensing, in a first brightness range in which the brightness of the subject is distributed in a predetermined brightness range, linear conversion is performed whereby a photoelectric charge commensurate with the amount of incident light is accumulated in the photoelectric conversion element to produce an electrical signal that varies linearly with respect to the amount of incident light, and, in a second brightness range in which the brightness of the subject is distributed elsewhere than in the first brightness range, logarithmic conversion is performed whereby a subthreshold current commensurate with the amount of incident light is passed via the transfer gate to produce an electrical signal that varies logarithmically with respect to the amount of incident light.

According to the present invention, the photoelectric charge that has overflowed from the photoelectric conversion element via the transfer gate is outputted as an overflow signal. Thus, according to the signal value of the overflow signal, it is possible to predict the integrated component to be added to the image signal. In this way, it is possible to realize a solid-state image-sensing device that has a pixel configuration similar to those conventionally adopted and that can be additionally furnished with an integrating capability easily. This helps prevent the solid-state image-sensing device from becoming unduly large or having an unduly low aperture ratio.

### BRIEF DESCRIPTION OF THE DRAWINGS

FIG. 1 is a block diagram showing the configuration of an image-sensing device embodying the present invention;

FIG. 2 is a block diagram showing the configuration of the solid-state image-sensing device provided in the image-sensing device shown in FIG. 1;

FIG. 3 is a block diagram showing the configuration of the sample-and-hold circuit and the correction circuit provided in the solid-state image-sensing device shown in FIG. 2;

FIGS. 4A and 4B are timing charts showing the states of relevant signals to illustrate an example of operation in the solid-state image-sensing device shown in FIG. 2;

FIGS. 5A to 5C are diagrams showing the potential states at different parts of a pixel provided in the solid-state image-sensing device shown in FIG. 2;

FIGS. 6A to 6C are diagrams showing the potential states at different parts of a pixel provided in the solid-state image-sensing device shown in FIG. 2;

FIGS. 7A to 7C are diagrams showing the potential states at different parts of a pixel provided in the solid-state image-sensing device shown in FIG. 2;

FIGS. 8A and 8B are diagrams showing the potential states at different parts of a pixel provided in the solid-state image-sensing device shown in FIG. 2;

FIG. 9 is a circuit diagram showing the configuration of a pixel provided in a solid-state image-sensing device;

FIG. 10 is a diagram schematically showing the structure of the pixel shown in FIG. 9; and

FIG. 11 is a block diagram showing the configuration of the sample-and-hold circuit and the correction circuit provided in a conventional solid-state image-sensing device.

### DETAILED DESCRIPTION OF PREFERRED EMBODIMENTS

Hereinafter, embodiments of the present invention will be described below with reference to the drawings.

Configuration of an Image-Sensing Device

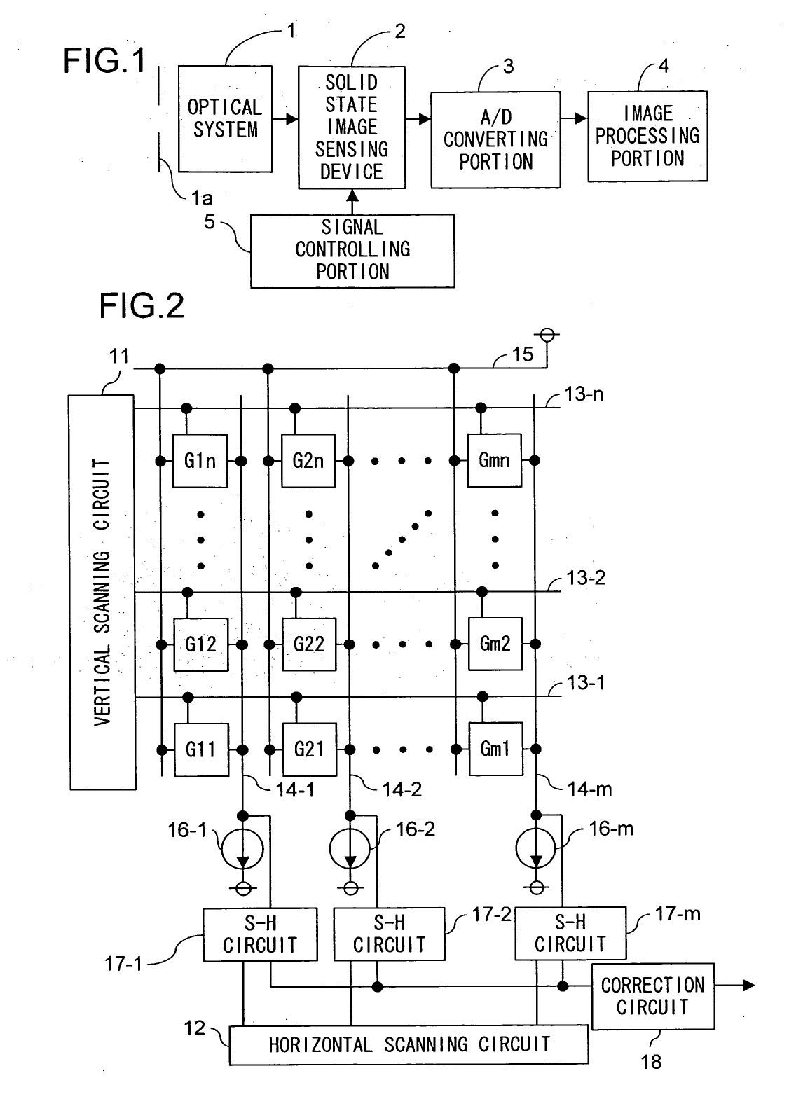

As shown in FIG. 1, an image-sensing device embodying the preset invention is provided with: an optical system 1 that is composed of a plurality of lenses; a mechanical shutter 1a that controls the exposure duration of the optical system 1; a solid-state image-sensing device 2 that converts the amount of light incident thereon through the optical system 1 into an electrical signal and outputs it as an image signal; an A/D converter 3 that converts the image signal outputted from the solid-state image-sensing device 2 into a digital signal; an image processor 4 that performs various kinds of image processing on the image signal thus converted into a digital signal by the A/D converter 3; and a signal controller 5 that controls the voltage levels of individual signals in the solid-state image-sensing device 2.

In the image-sensing device configured as descried above, while the mechanical shutter 1a is open, the light from the subject is incident through the optical system 1 on the solid-state image-sensing device 2. The solid-state image-sensing device 2 then performs image sensing and produces an image signal, which is then fed to the A/D converter 3, which then coverts the image signal into a digital signal. Meanwhile, the solid-state image-sensing device 2 receives necessary signals from the signal controller 5 so that a horizontal scanning circuit and a vertical scanning circuit provided in the solid-state image-sensing device 2 so operate that the image signals from individual pixels are sequentially fed to the A/D converter 3. The A/D converter 3 converts the image signals into digital signals, which are then fed to the image processor 4

Configuration of the Solid-State Image-Sensing Device

First, a solid-state image-sensing device embodying the present invention will be described with reference to FIG. 2. FIG. 2 is a diagram schematically showing the configuration of part of a two-dimensional MOS-type solid-state image-sensing device embodying the present invention.

In FIG. 2, reference symbols G11 to Gmn represent pixels arranged in rows and columns (in a matrix). Reference numeral 11 represents a vertical scanning circuit, which sequentially scans rows (lines) 13-1, 13-2, . . . , and 13-n via which the pixels are fed with a signal φV. Reference numeral 12 represents a horizontal scanning circuit, which sequentially reads, from one pixel after another in the horizontal direction, the photoelectric conversion signals delivered from the pixels to output signal lines 14-1, 14-2, . . . , and 14-m. Reference numeral 15 represents a power line. To the pixels are connected not only the lines 13-1 to 13-n, the output signal lines 14-1 to 14-m, and the power line 15 mentioned above, but also other lines (for example, clock lines, bias feed lines, etc.), though these are omitted in FIG. 2.

To the output signal lines 14-1 to 14-m, constant current sources 16-1 to 16-m, respectively, are connected. Moreover, sample-and-hold circuits (S-H circuits) 17-1 to 17-m are provided that sample-and-hold signals fed thereto from the pixels G11 to Gmn via the output signal lines 14-1 to 14-m. A correction circuit 18 receives the signals sampled-and-held in the sample-and-hold circuits 17-1 to 17-m, and corrects them to output, out of the solid-state image-sensing device, image signals having noise eliminated therefrom. The constant current sources 16-1 to 16-m receive, at one end of each, a direct-current voltage vPS.

In this configuration, as will be described later, the pixels G11 to Gmn each output, in addition to an image signal and a noise signal, an overflow signal originating from the potential appearing in a floating diffusion layer FD as a result of the photoelectric charge generated in an embedded photodiode PD during exposure overflowing into the floating diffusion layer FD. Thus, the sample-and-hold circuits 17-1 to 17-m each receive and sample-and-hold an image signal, a noise signal, and an overflow signal sequentially.

In the solid-state image-sensing device 2 configured as described above, the image signal, the noise signal, and the overflow signal outputted from a pixel Gab (where “a” represents a natural number fulfilling 1≦a≦m, and “b” represents a natural number fulfilling 1≦b≦m) are outputted via the output signal line 14-a, and are meanwhile amplified by the constant current source 16-a connected thereto. Then, the image signal, the noise signal, and the overflow signal outputted from the pixel Gab are sequentially fed to the sample-and-hold circuit 17-a so as to be sampled-and-held therein.

Then, the image signal sampled-and-held in the sample-and-hold circuit 17-a is fed therefrom to the correction circuit 18, and subsequently the noise signal likewise sampled-and-held in the sample-and-hold circuit 17-a is fed therefrom to the correction circuit 18. The correction circuit 18 corrects the image signal fed from the sample-and-hold circuit 17-a based on the noise signal likewise fed from the sample-and-hold circuit 17-a. Then, the correction circuit 18 receives the overflow signal from the sample-and-hold circuit 17-a, and corrects the image signal, which has noise already eliminated therefrom based on the noise signal, for the variation of the incident light during the exposure period. The correction circuit 18 then outputs the resulting signal out of the solid-state image-sensing device.

Moreover, the signal controller 5 feeds signals to the vertical scanning circuit 11 of the solid-state image-sensing device 2 so that the vertical scanning circuit 11 outputs signals for setting the timing with which the transfer gates of the pixels of each row are closed and for setting the timing with which the pixels G11 to Gmn start image sensing and output the image signals, the noise signals, and the overflow signals. Furthermore, the signal controller 5 feeds signals to the horizontal scanning circuit 12 so that the horizontal scanning circuit 12 outputs signals for setting the timing with which the sample-and-hold circuits 17-1 to 17-m output the image signals, the noise signals, and the overflow signals to the correction circuit 18.

Configuration of the Pixels

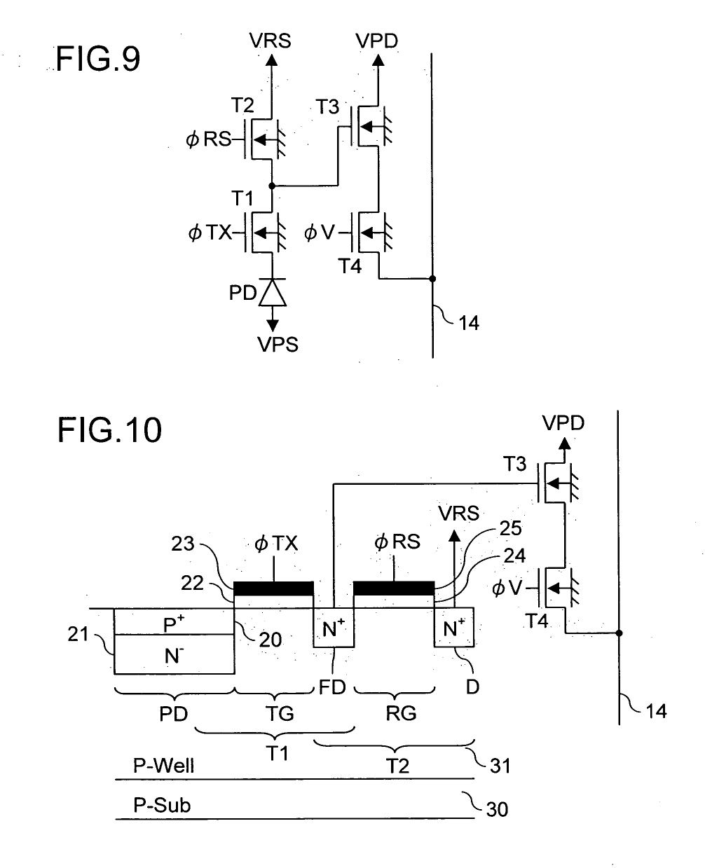

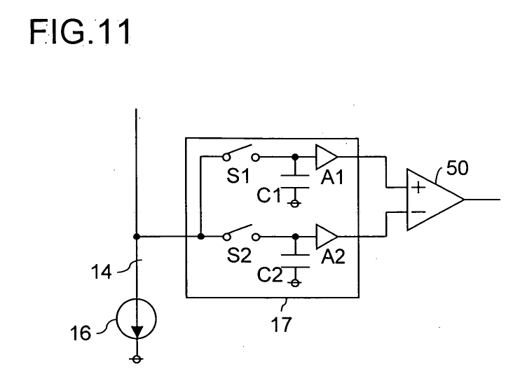

The pixels provided in the solid-state image-sensing device configured as shown in FIG. 2 are configured as described earlier in the “Background of the Invention” part of this specification with reference to FIG. 9. More specifically, as shown in FIG. 10, each pixel is provided with: an embedded photodiode PD composed of a P-type well layer 31 formed on a P-type substrate 30, and a highly-doped P-type layer 20 and an N-type embedded layer 21 formed on the surface of the P-type well layer 31; a MOS transistor T1 composed of a transfer gate TG having a gate electrode 23 formed, with an insulating film 22 laid interposed, on the surface of a region adjacent to the region where the embedded photodiode PD is formed, the N-type embedded layer 21, and an N-type floating diffusion layer FD; a MOS transistor T2 composed of a reset gate RG having a gate electrode 25 formed, with an insulating film 24 interposed, on the surface of a region adjacent to the N-type floating diffusion layer FD, the N-type floating diffusion layer FD, and an N-type diffusion layer D; a MOS transistor T3 whose gate is connected to the N-type floating diffusion layer FD; and a MOS transistor T4 whose drain is connected to the source of the MOS transistor T3. With the embedded photodiode PD formed within the pixel in this way, the potential at the surface of the P-type layer 20 is kept equal to the potential at the channel stopper layer formed by the P-type layer located around the embedded photodiode PD.

The MOS transistors T1 to T4 are all N-channel MOS transistors. A direct-current voltage VPS is applied to the cathode of the photodiode PD and to the backgates of the MOS transistors T1 to T4, and direct-current voltages VRS and VPD are applied to the drains of the MOS transistors T2 and T3, respectively. Moreover, signals φTX, φRS, and φV are fed to the gates of the MOS transistors T1, T2, and T4. Furthermore, the source of the MOS transistor T4 is connected to an output signal line 14 (corresponding to the output signal lines 14-1 to 14-m in FIG. 1).

In this embodiment, in each of the pixels provided in the solid-state image-sensing device 2, the signal φTX fed to the transfer gate TG is a signal whose state shifts among three voltage levels VH, VM, and VL (where VH>VM>VL). Here, by setting the voltage level VM of the signal φTX at an appropriate value, it is possible to make the MOS transistor T1 operate in a subthreshold region when the amount of photoelectric charge generated by the embedded photodiode PD is larger than a predetermined value. This makes it possible to switch photoelectric conversion between linear conversion and logarithmic conversion according to the amount of incident light. In addition, by varying the voltage level VM of the signal φTX, it is possible to vary the inflection point across which the photoelectric conversion performed by the embedded photodiode PD and the MOS transistor T1 is switched between linear conversion and logarithmic conversion.

Configuration of the Sample-And-Hold Circuits and the Correction Circuit

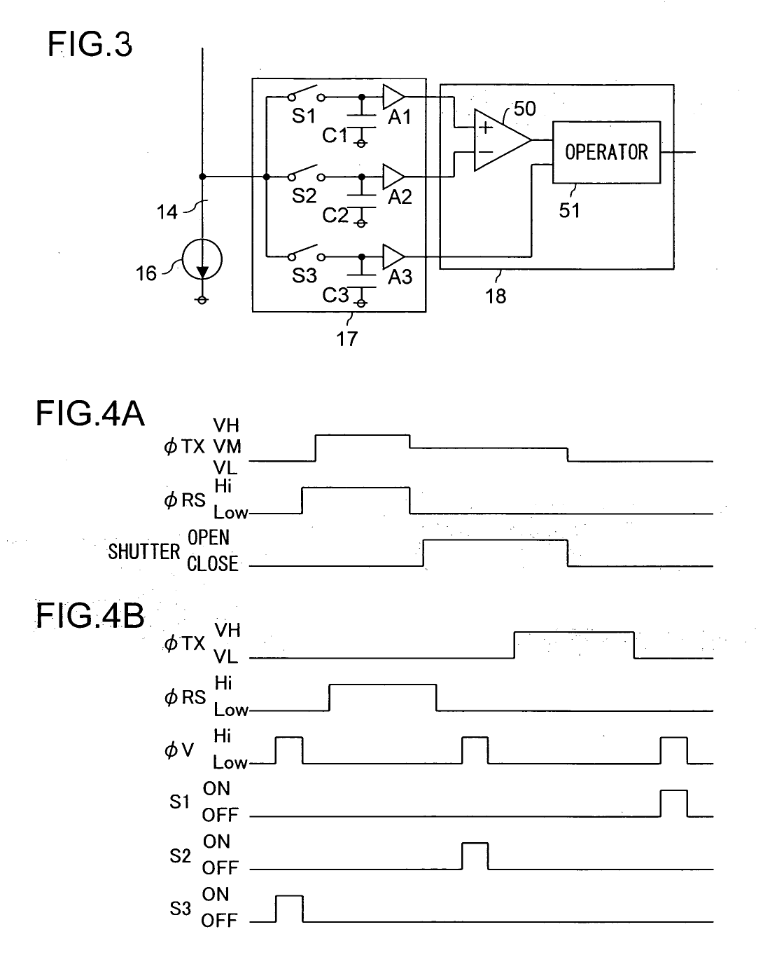

The configuration of the sample-and-hold circuits 17-1 to 17-m and the correction circuit 18 will be described below with reference to FIG. 3. FIG. 3 is a block diagram showing the internal configuration of a sample-and-hold circuit and the correction circuit.

As shown in FIG. 3, the sample-and-hold circuit 17 (corresponding to the sample-and-hold circuits 17-1 to 17-m in FIG. 1) is provided with: switches S1 to S3 that are connected, in parallel with one another, to the node between the output signal line 14 (corresponding to the output signal lines 14-1 to 14-m in FIG. 1) and the constant current source 16 (corresponding to the constant current sources 16-1 to 16-m in FIG. 1); and capacitors C1 to C3 and buffer amplifiers A1 to A3 that are connected, via the switches S1 to S3, respectively, to the output signal line 14. On the other hand, the correction circuit 18 is provided with: a subtracter 50 that is built with a differential amplifier circuit that receives the outputs of the buffer amplifiers A1 and A2 of each column; and an operator 51 that corrects the output of the subtracter 50 based on the output of the buffer amplifier A3.

In this configuration, when a pixel outputs an image signal, the switch S1 is turned on, so that the image signal is sampled-and-held in the capacitor C1; when the pixel outputs a noise signal, the switch S2 is turned on, so that the noise signal is sampled-and-held in the capacitor C2; when a pixel outputs an overflow signal, the switch S3 is turned on, so that the overflow signal is sampled-and-held in the capacitor C3. When the image signal, the noise signal, and the overflow signal are thus sampled-and-held in the capacitors C1 to C3, respectively, the buffer amplifiers A1 to A3 are all turned on.

Now, the image signal and the noise signal sampled-and-held in the capacitors C1 and C2, respectively, are fed via the buffer amplifiers A1 and A2 to the subtracter 50, which then subtracts the noise signal from the image signal to output an image signal having noise eliminated therefrom. The image signal thus having noise eliminated therefrom is fed to the operator 51, and also the overflow signal sampled-and-held in the capacitor C3 is fed via the buffer amplifier A3 to the operator 51. Based on the value of the overflow signal, the operator 51 recognizes the variation of the amount of incident light during the exposure period, and corrects the image signal for the thus recognized variation of the amount of incident light. The corrected image signal is then fed out of the solid-state image-sensing device.

Operation of the Solid-State Image-Sensing Device

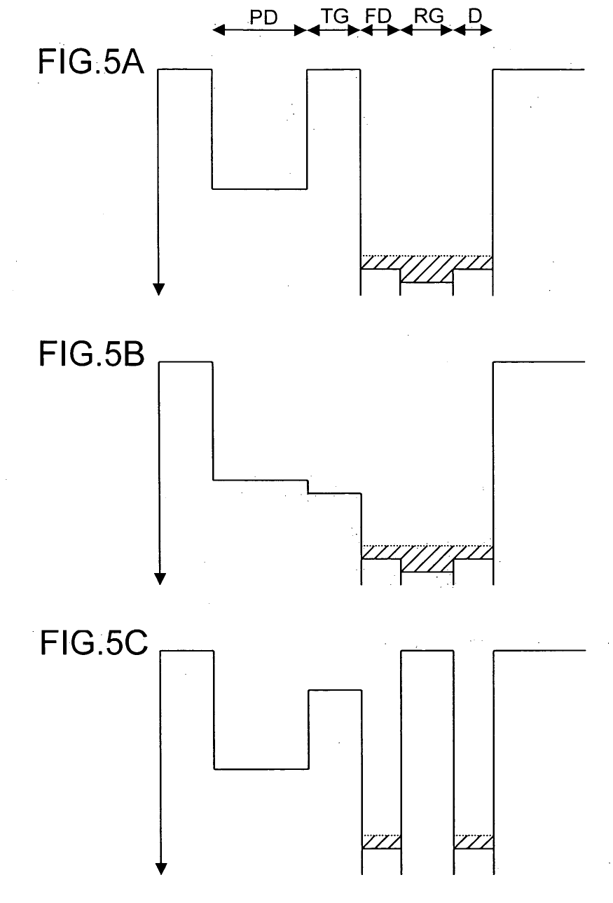

The operation of the solid-state image-sensing device provided with the pixels, the sample-and-hold circuits, and the correction circuit configured as described above will be described below with reference to the timing charts in FIGS. 4A and 4B. FIG. 4A is a timing chart showing the operation performed simultaneously in all the pixels during the vertical blanking period, and FIG. 4B is a timing chart showing the operation performed for one row after another during the horizontal blanking period. FIGS. 5A to 8B are diagrams showing the potential states at different parts of the pixel.

First, with reference to FIG. 4A, a description will be given of the level shifts of relevant signals that occur when image sensing is performed simultaneously in all the pixels G11 to Gmn during the vertical blanking period. At first, the signals φTX and φRS are both kept low, so that, in each of the pixels G11 to Gmn, the MOS transistors T1 and T2 are kept off, and the mechanical shutter 1a is kept closed. Thereafter, the signal φRS is turned high simultaneously, so that, in all the pixels G11 to Gmn, the potential at the reset gate RG is raised as shown in FIG. 5A, and then the voltage level of the signal φTX is turned to VH simultaneously, so that, in all the pixels G11 to Gmn, the potential at the transfer gate TG is raised as shown in FIG. 5B. In this way, in each of the pixels G11 to Gmn, the N-type floating diffusion layer FD and the embedded photodiode PD are initialized.

Then, the signal φRS is turned low and the signal φTX is turned to VM, so that, in each of the pixels G11 to Gmn, the potential states at the embedded photodiode PD, the N-type floating diffusion layer FD, the transfer gate TG, and the reset gate RG have the relationship shown in FIG. 5C. Specifically, the potential at the reset gate RG is lowered, and the potential appearing at the transfer gate TG is brought to somewhere between the potential at the embedded photodiode PD and the potential at the reset gate RG. In this state, when the signal φRS is turned low and thereby the MOS transistor T2 is turned off so that the N-type floating diffusion layer FD is brought into a floating state, the photoelectric charge overflowing from the embedded photodiode PD is accumulated in the N-type floating diffusion layer FD. Thereafter, the mechanical shutter 1a is opened, so that the pixels G11 to Gmn are each exposed.

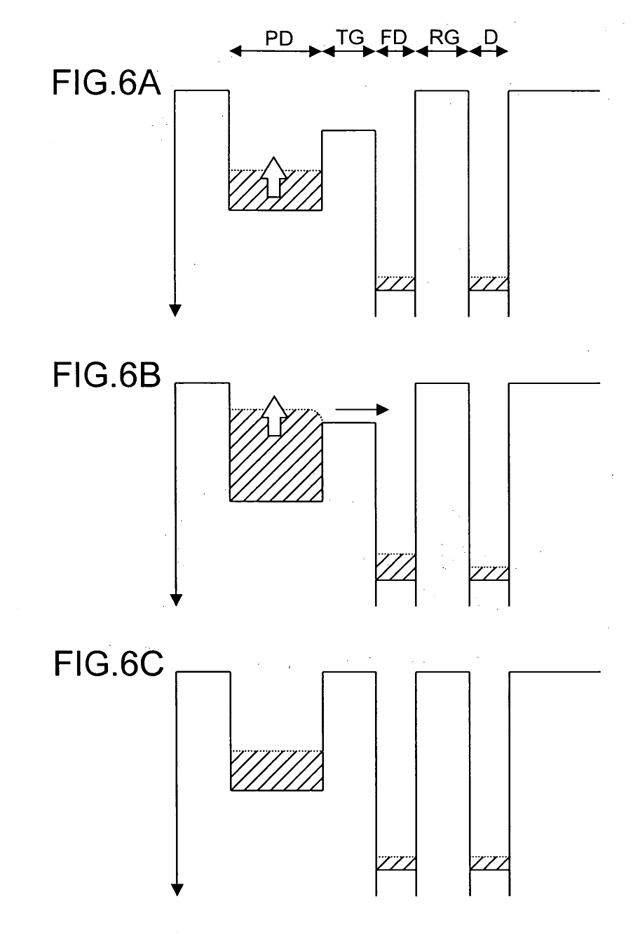

When exposure starts in this way, a photoelectric charge commensurate with the amount of incident light is generated and accumulated in the embedded photodiode PD, causing the potential at the embedded photodiode PD to vary. Here, if the brightness of the subject is low, the photoelectric charge is so accumulated in the embedded photodiode PD that, as shown in FIG. 6A, the potential at the embedded photodiode PD varies linearly according to the integral of the amount of incident light.

By contrast, if the brightness of the subject is high, when the potential at the embedded photodiode PD becomes so low that its difference from the potential at the transfer gate TG approaches a threshold value, as shown in FIG. 6B, the MOS transistor T1, including the transfer gate TG, operates in a subthreshold region, permitting a current to flow therethrough. Thus, the potential appearing at the embedded photodiode PD varies in proportion to the logarithm of the current generated by photoelectric conversion. Here, since the potential at the reset gate RG is set low, the photoelectric charge that has overflowed via the transfer gate TG is accumulated in the N-type floating diffusion layer FD, and thus, just by the amount of photoelectric charge that has overflowed during the duration of exposure, the potential at the N-type floating diffusion layer FD becomes lower.

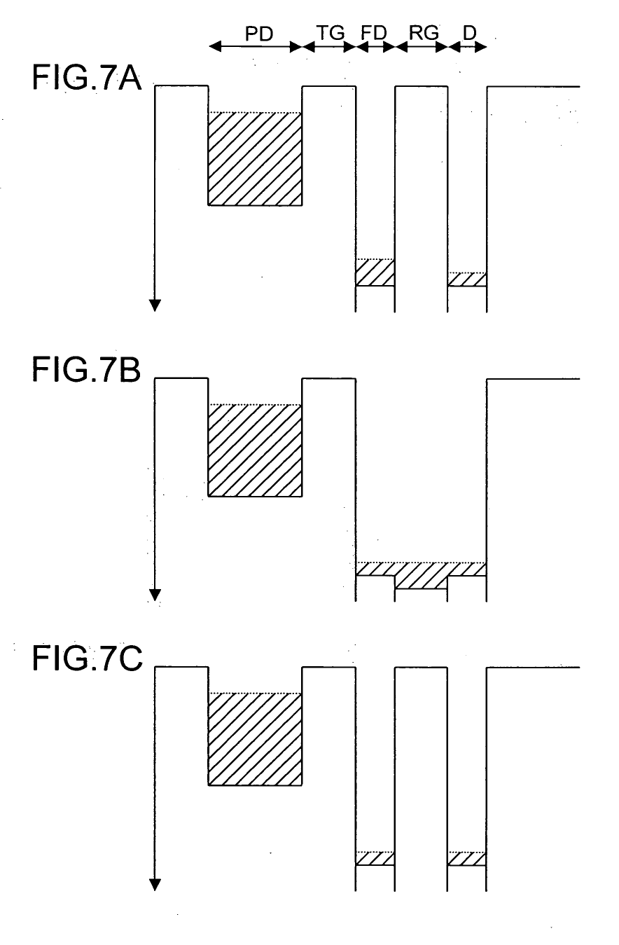

Then, the mechanical shutter 1a is closed to end the exposure. At this point, the voltage level of the signal φTX is turned to VL and, in each of the pixels G11 to Gmn, as shown in FIG. 6C or 7A, the potential at the transfer gate TG is lowered, so that the potential that has been generated in the embedded photodiode PD is sustained. It should be noted that FIG. 6C shows the potential states observed when light is incident from a low-brightness subject while FIG. 7A shows the potential states observed when light is incident from a high-brightness subject. Specifically, when a low-brightness subject is image-sensed, no photoelectric charge overflows from the embedded photodiode PD, and therefore, as shown in FIG. 6C, the potential at the N-type floating diffusion layer FD remains unchanged. By contrast, when a high-brightness subject is image-sensed, a photoelectric charge overflows from the embedded photodiode PD, and therefore, as shown in FIG. 7A, just by the amount of photoelectric charge that has overflowed during the exposure, the potential at the N-type floating diffusion layer FD becomes lower. Incidentally, even in a case where nothing like the overflow signal described above is acquired, when the brightness of the subject is high, a signal corresponding to the amount of electric charge obtained when the transfer gate TG is turned low into an off state is outputted as an image signal; that is, non-integrating image sensing is performed.

While all the pixels G11 to Gmn are performing image sensing simultaneously as described above, the signal φV is kept low so that the MOS transistor T4 is kept off, and, in the sample-and-hold circuits 17-1 to 17-m, the switches S1 to S3 are kept off. After this vertical blanking period, that is, on completion of the image sensing by all the pixels, then, during the horizontal blanking period, the signals φTX, φRS, and φV, which are fed to one row after another of the solid-state image-sensing device 2, and the switches S1 to S3 are controlled as shown in FIG. 4B, so that, for each row, the image signal, the noise signal, and the overflow signal are sampled-and-held in the sample-and-hold circuits 17-1 to 17-m.

First, with respect to the pixels G11 to Gmn, which have now completed image sensing and are in the states shown in FIGS. 6C and 7A, the operations shown in FIG. 4B are performed for one row after another, starting with the first row. In the following description, the operations performed for the pixels G1k to Gmk in the kth row (where “k” represents an integer greater than or equal to 1 but smaller or equal to n) will be explained. First, to sample-and-hold in the capacitor C3 the overflow signal that represents the potential due to the photoelectric charge that has overflowed from the embedded photodiode PD into the N-type floating diffusion layer FD during exposure, a high-level pulse is fed, as the signal φV, to each of the pixels G1k to Gmk to turn the MOS transistor T4 on, and, in each of the sample-and-hold circuits 17-1 to 17-m, the switch S3 is turned on.

Now, a current corresponding to the potential state at the N-type floating diffusion layer FD flows through the MOS transistor T3, so that a voltage signal corresponding to the potential state at the N-type floating diffusion layer FD is fed to the capacitor C3. Thereafter, the switch S3 is turned off and the signal φV is turned low so that, in each of the sample-and-hold circuits 17-1 to 17-m, a voltage signal is, as the overflow signal of the corresponding one of the pixels G1k to Gmk, sampled-and-held in the capacitor C3.

When the overflow signal is sampled-and-held in each of the sample-and-hold circuits 17-1 to 17-m in this way, then, in each of the pixels G1k to Gmk, the signal φRS is turned high to turn the MOS transistor T2 on so that, as shown in FIG. 7B, the potential at the reset gate RG is raised. In this way, the potential at the floating diffusion layer FD is reset. Then, the; signal φRS is turned low to turn the MOS transistor T2 off so that, as shown in FIG. 4C, the potential at the reset gate RG is lowered and the potential at the floating diffusion layer FD is brought into a floating state.

Then, to sample-and-hold in the capacitor C2 the noise signal that represents the potential state of the floating diffusion layer FD after resetting, a high-level pulse is fed, as the signal φV, to each of the pixels G1k to Gmk to turn the MOS transistor T2 on, and, in each of the sample-and-hold circuits 17-1 to 17-m, the switch S2 is turned on. Thus, a voltage signal corresponding to the potential state at the N-type floating diffusion layer FD is fed to the capacitor C2. Thereafter, the switch S2 is turned off and the signal φV is turned low, so that, in each of the sample-and-hold circuits 17-1 to 17-m, a voltage signal is, as the noise signal of the corresponding one of the pixels G1k to Gmk, sampled-and-held in the capacitor C2.

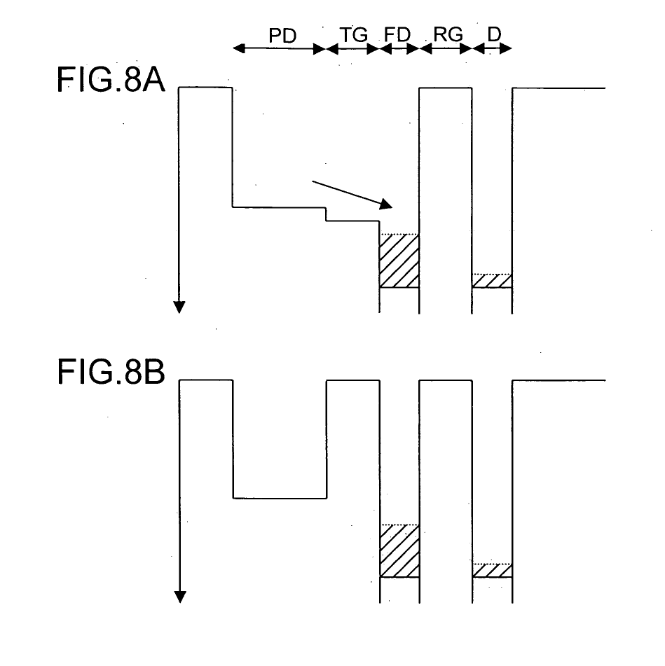

When the noise signal is sampled-and-held in each of the sample-and-hold circuits 17-1 to 17-m in this way, then, in each of the pixels G1k to Gmk, the voltage level of the signal φTX is turned to VH to turn the MOS transistor T1 on so that, as shown in FIG. 8A, the potential at the transfer gate TG is raised. Now, the photoelectric charge accumulated in the embedded photodiode PD transfers into the N-type floating diffusion layer FD, so that the potential at the N-type floating diffusion layer FD is brought to a value corresponding to the potential at the embedded photodiode PD. Then, the voltage level of the signal φTX is turned to VL, so that, as shown in FIG. 8B, the potential at the transfer gate TG is lowered. This inhibits the transfer of the photoelectric charge from the embedded photodiode PD, and thereby permits the potential at the embedded photodiode PD to be retained in the N-type floating diffusion layer FD.

Thereafter, to sample-and-hold in the capacitor C1 the image signal that represents the potential at the embedded photodiode PD as retained in the floating diffusion layer FD, a high-level pulse is fed, as the signal φV, to each of the pixels G1k to Gmk to turn the MOS transistor T4 on, and, in each of the sample-and-hold circuits 17-1 to 17-m, the switch S1 is turned on. Thus, a voltage signal corresponding to the potential retained in the floating diffusion layer FD is fed to the capacitor C1. Thereafter, the switch S1 is turned off and the signal φV is turned low, so that, in each of the sample-and-hold circuits 17-1 to 17-m, a voltage signal is, as the image signal of the corresponding one of the pixels G1k to Gmk, sampled-and-held in the capacitor C1.

When the image signal, the noise signal, and the overflow signal from each of the pixels G1k to Gmk have been sampled-and-held in the capacitors C1 to C3 of the corresponding one of the sample-and-hold circuits 17-1 to 17-m in this way, then, in one after another of the sample-and-hold circuits 17-1 to 17-m, in increasing order of their suffixed numbers, the buffer amplifiers A1 to A3 are turned on. Thus, for one pixel after another, the image signal, the noise signal, and the overflow signal sampled-and-held in the capacitors C1 to C3 are fed via the buffer amplifiers A1 to A3 to the correction circuit 18.

Specifically, in the sample-and-hold circuit 17-i (where “i” represents an integer greater than or equal to 1 but smaller than or equal to m), when the buffer amplifiers A1 to A3 are turned on, the image signal and the noise signal of the pixel Gik are fed via the buffer amplifiers A1 and A2 to the subtracter 50 of the correction circuit 18. The subtracter 50 subtracts the noise signal from the image signal, so that the image signal of the pixel Gik having noise eliminated therefrom is fed to the operator 51. The operator 51 also receives the overflow signal of the pixel Gik via the buffer amplifier A1.

The operator 51 is provided with a reference value table that contains the relationship between, on one side, varying values X of the image signal having noise eliminated therefrom through the subtraction by the subtracter 50 and, on the other side, the corresponding values Y (the reference value Y) of the overflow signal obtained when there is no variation in the amount of incident light during the exposure period. Provided with this reference value table, when the operator 51 receives the image signal from the subtracter 50, it first checks whether or not the value X of the image signal falls in the linear conversion range or in the logarithmic conversion range.

Whether the image signal falls in the linear or logarithmic conversion range may be checked by checking whether or not, when the value Z of the overflow signal of the same pixel as the one whose image signal has just been processed by the subtracter 50 is positive, the value is smaller than or equal to a predetermined threshold value Th (for example, zero). Specifically, when the value of the overflow signal is smaller than or equal to the threshold value Th, it means that the amount of photoelectric charge generated in the embedded photodiode PD is small and thus that the brightness of the subject being image-sensed is low; thus the linear conversion range is confirmed in which the embedded photodiode PD performs integration. By contrast, when the value of the overflow signal is greater than or equal to the threshold value Th, it means that the amount of photoelectric charge generated in the embedded photodiode PD is large and thus that the brightness of the subject being image-sensed is high; thus, the logarithmic conversion range is confirmed in which a subthreshold current flows from the embedded photodiode PD.

When the value X of the image signal is found to fall in the linear conversion range, no correction is performed based on the reference value table, and the image signal having noise eliminated therefrom by the subtracter 50 is outputted, as it is, from the operator 51. By contrast, when the value X of the image signal is found to fall in the logarithmic conversion range, the reference value Y corresponding to the value X of the image signal having noise eliminated therefrom by the subtracter 50 is located in the reference value table. Then, with the reference value Y located in the reference value table, the value Z of the overflow signal fed to the operator 51 via the buffer amplifier A3 is compared. Then, based on the result of this comparison between the reference value Y and the overflow signal value Z, the value X of the image signal having noise eliminated therefrom through the subtraction by the subtracter 50 is corrected.

Specifically, if the overflow signal value Z is smaller than the reference value Y, it indicates that, during the exposure period, there occurred a state in which the amount of incident light was smaller (i.e. the brightness was lower) than that corresponding to the image signal observed at the moment that the mechanical shutter 1a is closed and simultaneously the level of the signal φTX is turned to VL. Moreover, by referring to the difference between the overflow signal value Z and the reference value Y, it is also possible to quantitatively recognize the degree of low brightness and accordingly correct the value X of the image signal. By contrast, if the overflow signal value Z is greater than the reference value Y, it indicates that, during the exposure period, there occurred a state in which the amount of incident light was larger (i.e. the brightness was higher) than that corresponding to the image signal observed at the moment that the mechanical shutter 1a is closed and simultaneously the level of the signal φTX is turned to VL. Moreover, by referring to the difference between the overflow signal value Z and the reference value Y, it is also possible to quantitatively recognize the degree of high brightness and accordingly correct the value X of the image signal. Thus, even when the image signal having noise eliminated therefrom has a value falling in the logarithmic conversion range, the operator 51 can add thereto an integrated component according to the value of the overflow signal to output an image signal containing the integrated component.

When the image signal of the pixel Gik thus having noise eliminated therefrom and then corrected is outputted from the operator 51, then the buffer amplifiers A1 to A3 in the sample-and-hold circuit 17-(i+1) are turned on, and the correction circuit 18 operates in a similar manner as described above to output the image signal of the pixel G(i+1)k having noise eliminated therefrom and then corrected. In this way, for one after another of the pixels G1k, G2k, . . . , and Gmk, in this order, the image signal having noise eliminated therefrom and then corrected is outputted. Then, the pixels G1(k+1) to Gm(k+1) in the next row, namely the (k+1)th row, the sample-and-hold circuits 17-1 to 17-m, and the correction circuit 18 operate in a similar manner as described above. As a result of such sampling-and-holding and correction being performed for one row after another, the image signal from each of the pixels G11 to Gmn is outputted after having noise eliminated therefrom and then being corrected.

In this embodiment, the solid-state image-sensing device 2 is provided with only one of the correction circuit 18. Alternatively, for example in a case where the solid-state image-sensing device 2 is provided with color filters so that there are as many channels as there are kinds of color filters, the solid-state image-sensing device 2 may be provided with as many correction circuits 18 as the channels provided.

Moreover, the operator 51 may be provided with different versions of the reference value table that contains the relationship between, on one side, varying values X of the image signal having noise eliminated therefrom and, on the other side, the corresponding values Y. Specifically, the operator 51 may be provided with different reference value tables for different exposure conditions in terms of the exposure duration, the aperture value, etc. and for different values in terms of the voltage level VM of the signal φTX. Where this is the case, the operator 51 selects a reference value table that suits particular shooting conditions in terms of the exposure duration and other exposure conditions and the voltage level VM, and performs correction based on the selected reference value table. In this way, it is possible to add a more accurate integrated component to an image signal that falls in the logarithmic conversion range.

Moreover, in each pixel provided in the solid-state image-sensing device 2, the MOS transistors T1 to T4 are all built as N-channel MOS transistors. Where the MOS transistors T1 to T4 are all built as N-channel MOS transistors in this way, they are formed in a P-type well layer or in a P-type substrate. Alternatively, while the MOS transistors T1 and T2 are built as N-channel MOS transistors, the MOS transistors T3 and T4 may be built as P-channel MOS transistors. The solid-state image-sensing device may even be given any circuit configuration other than specifically shown in FIG. 9.

In this embodiment, in each pixel provided in the solid-state image-sensing device 2, the potential state at the N-type floating diffusion layer FD as observed when it is reset via the reset gate RG before the photoelectric charge in the embedded photodiode PD is transferred to the N-type floating diffusion layer FD is read out as a reset signal, and all the pixels are reset again during image sensing. Alternatively, it is also possible to first transfer the photoelectric charge in the embedded photodiode PD to the N-type floating diffusion layer FD to read an image signal and then reset the N-type floating diffusion layer FD via the reset gate RG to output a noise signal.

Furthermore, in each pixel provided in the solid-state image-sensing device 2, the potential given to the transfer gate TG during image sensing is set at a value that permits switching between linear conversion and logarithmic conversion. Instead, it may be set at a value that maintains linear conversion all the time. In a case where linear conversion is maintained all the time in this way, when a high-brightness subject is image-sensed, the photoelectric charge that have overflowed over the transfer gate TG is sustained in the N-type floating diffusion layer FD, and an overflow signal due to the thus retained photoelectric charge is sampled-and-held in the capacitor C3. Thus, in the correction circuit 18, for example by adding the signal value of the overflow signal to the image signal having noise eliminated therefrom by the subtracter 50, it is possible to output an image signal with a signal value in a high-brightness range, and in this way it is possible to increase the dynamic range of the solid-state image-sensing device 2.

What is claimed is:

1. A solid-state image-sensing device comprising:
a pixel including
a photoelectric conversion element that generates and internally accumulates a photoelectric charge according to an amount of incident light,
a charge holder that temporarily holds the photoelectric charge transferred from the photoelectric conversion element, and
a transfer gate that is formed between the photoelectric conversion element and the charge holder,
the pixel performing non-integrating image sensing to yield an output commensurate with the amount of incident light observed at a moment that the transfer gate performs transfer; and
a calculation circuit
that reads out from the pixel, as an overflow signal, a photoelectric charge that overflows from the photoelectric conversion element via the transfer gate to be accumulated in the charge holder while the pixel is performing the image sensing, and
that performs correction on, based on the overflow signal, an image signal outputted from the pixel having performed the image sensing.

2. The solid-state image-sensing device of claim 1, wherein
the pixel further includes a reset gate that permits a potential state of the charge holder to be initialized,
when the pixel performs the image sensing, the charge holder is made, via the reset gate, ready to hold the photoelectric charge overflowing from the photoelectric conversion element via the transfer gate, and
when the pixel outputs a signal, the photoelectric charge accumulated in the charge holder is read out as the overflow signal, then the charge holder is initialized via the reset gate, and then the photoelectric charge accumulated in the photoelectric conversion element is read out as an image signal via the charge holder.

3. The solid-state image-sensing device of claim 2, wherein
when the pixel outputs a signal,
a potential state of the charge holder observed when the charge holder is initialized via the reset gate after the overflow signal is outputted is outputted as a noise signal, and then
the charge holder is made, via the reset gate, ready to hold the photoelectric charge accumulated in the photoelectric conversion element via the transfer gate, then the photoelectric charge accumulated in the photoelectric conversion element via the transfer gate is transferred to the charge holder, and then the photoelectric charge transferred to the charge holder is outputted as the image signal.

4. The solid-state image-sensing device of claim 3, wherein
in the calculation circuit, the image signal outputted from the pixel has noise eliminated therefrom based on the noise signal, and is then corrected based on the overflow signal.

5. The solid-state image-sensing device of claim 3, further comprising:
a sample-and-hold circuit that temporarily holds the image signal, the noise signal, and the overflow signal outputted from the pixel.

6. The solid-state image-sensing device of claim 2, wherein
when the pixel outputs a signal,
after the overflow signal is outputted, the charge holder is initialized via the reset gate, then
the charge holder is made, via the reset gate, ready to hold the photoelectric charge accumulated in the photoelectric conversion element via the transfer gate, then the photoelectric charge accumulated in the photoelectric conversion element via the transfer gate is transferred to the charge holder, and then the photoelectric charge transferred to the charge holder is outputted as the image signal, and then
the charge holder is initialized via the reset gate so that a potential state of the charge holder thus initialized is outputted as a noise signal.

7. The solid-state image-sensing device of claim 6, wherein
in the calculation circuit, the image signal outputted from the pixel has noise eliminated therefrom based on the noise signal, and is then corrected based on the overflow signal.

8. The solid-state image-sensing device of claim 6, further comprising:
a sample-and-hold circuit that temporarily holds the image signal, the noise signal, and the overflow signal outputted from the pixel.

9. The solid-state image-sensing device of claim 1, wherein
when the pixel performs the non-integrating image sensing,
logarithmic conversion is achieved as a result of a subthreshold current commensurate with the amount of incident light flowing through the transfer gate and thereby producing an electrical signal that varies logarithmically with the amount of incident light, and
the overflow signal is produced as a result of an electric charge being accumulated in the charge holder by the subthreshold current.

10. The solid-state image-sensing device of claim 2, wherein
when the pixel performs the image sensing,
in a first brightness range in which brightness of a subject is distributed in a predetermined brightness range, linear conversion is performed whereby a photoelectric charge commensurate with the amount of incident light is accumulated in the photoelectric conversion element to produce an electrical signal that varies linearly with respect to the amount of incident light, and
in a second brightness range in which the brightness of the subject is distributed elsewhere than in the first brightness range, logarithmic conversion is performed whereby a subthreshold current commensurate with the amount of incident light is passed via the transfer gate to produce an electrical signal that varies logarithmically with respect to the amount of incident light.

11. The solid-state image-sensing device of claim 10, wherein
the calculation circuit does not perform the correction on the image signal obtained as a result of the pixel performing the linear conversion.

12. The solid-state image-sensing device of claim 11, wherein
the calculation circuit recognizes the image signal as being obtained through the linear conversion or the logarithmic conversion by comparing the overflow signal with a predetermined threshold value.

13. The solid-state image-sensing device of claim 1, wherein
an integrated component that is fed to the calculation circuit to perform the correction based on the overflow signal is varied according to shooting conditions.

14. A solid-state image-sensing device comprising:
a pixel including
a photoelectric conversion element that generates and internally accumulates a photoelectric charge according to an amount of incident light,
a charge holder that temporarily holds the photoelectric charge transferred from the photoelectric conversion element,
a transfer gate that is formed between the photoelectric conversion element and the charge holder, and
a reset gate via which a potential state of the charge holder is initialized,
the pixel performing non-integrating image sensing to yield an output commensurate with the amount of incident light observed at a moment that the transfer gate performs transfer; and
a calculation circuit
that reads out from the pixel, as an overflow signal, a photoelectric charge that overflows from the photoelectric conversion element via the transfer gate to be accumulated in the charge holder while the pixel is performing the image sensing, and
that performs correction on, based on the overflow signal, an image signal outputted from the pixel having performed the image sensing, and
a sample-and-hold-circuit that temporarily holds the image signal and the overflow signal outputted from the pixel,
wherein
when the pixel performs the image sensing, the charge holder is made, via the reset gate, ready to hold the photoelectric charge overflowing from the photoelectric conversion element via the transfer gate, and
when the pixel outputs a signal, the photoelectric charge accumulated in the charge holder is read out as the overflow signal, then the charge holder is initialized via the reset gate, and then the photoelectric charge accumulated in the photoelectric conversion element is read out as the image signal via the charge holder.

15. The solid-state image-sensing device of claim 14, wherein
when the pixel outputs a signal,
a potential state of the charge holder observed when the charge holder is initialized via the reset gate after the overflow signal is outputted is outputted as a noise signal, and then
the charge holder is made, via the reset gate, ready to hold the photoelectric charge accumulated in the photoelectric conversion element via the transfer gate, then the photoelectric charge accumulated in the photoelectric conversion element via the transfer gate is transferred to the charge holder, and then the photoelectric charge transferred to the charge holder is outputted as the image signal.

16. The solid-state image-sensing device of claim 14, wherein
when the pixel outputs a signal,
after the overflow signal is outputted, the charge holder is initialized via the reset gate, then
the charge holder is made, via the reset gate, ready to hold the photoelectric charge accumulated in the photoelectric conversion element via the transfer gate, then the photoelectric charge accumulated in the photoelectric conversion element via the transfer gate is transferred to the charge holder, and then the photoelectric charge transferred to the charge holder is outputted as the image signal, and then
the charge holder is initialized via the reset gate so that a potential state of the charge holder thus initialized is outputted as a noise signal.

17. A solid-state image-sensing device comprising:
a pixel including
a photoelectric conversion element that generates and internally accumulates a photoelectric charge according to an amount of incident light,
a charge holder that temporarily holds the photoelectric charge transferred from the photoelectric conversion element, and
a transfer gate that is formed between the photoelectric conversion element and the charge holder,
the pixel performing non-integrating image sensing to yield an output commensurate with the amount of incident light observed at a moment that the transfer gate performs transfer; and
a calculation circuit
that reads out from the pixel, as an overflow signal, a photoelectric charge that overflows from the photoelectric conversion element via the transfer gate to be accumulated in the charge holder while the pixel is performing the image sensing, and
that performs correction on, based on the overflow signal, an image signal outputted from the pixel having performed the image sensing,
wherein
when the pixel performs the image sensing,
in a first brightness range in which brightness of a subject is distributed in a predetermined brightness range, linear conversion is performed whereby a photoelectric charge commensurate with the amount of incident light is accumulated in the photoelectric conversion element to produce an electrical signal that varies linearly with respect to the amount of incident light, and
in a second brightness range in which the brightness of the subject is distributed elsewhere than in the first brightness range, logarithmic conversion is performed whereby a subthreshold current commensurate with the amount of incident light is passed via the transfer gate to produce an electrical signal that varies logarithmically with respect to the amount of incident light.

18. The solid-state image-sensing device of claim 17, wherein
the calculation circuit does not perform the correction on the image signal obtained as a result of the pixel performing the linear conversion.

19. The solid-state image-sensing device of claim 18, wherein
the calculation circuit recognizes the image signal as being obtained through the linear conversion or the logarithmic conversion by comparing the overflow signal with a predetermined threshold value.
